(19) United States
(12) Patent Application Publication
(10) Pub. No.: US 2025/0291043 A1
(43) Pub. Date: Sep. 18, 2025

(54) SONAR APPARATUS AND OBJECT DETECTION METHOD

(71) Applicant: Panasonic Automotive Systems Co., Ltd., Kanagawa (JP)

(72) Inventors: Kenji MIYANAGA, Kanagawa (JP); Tadashi MORITA, Kanagawa (JP); Takuya IWAMOTO, Osaka (JP)

(21) Appl. No.: 19/076,813

(22) Filed: Mar. 11, 2025

(30) Foreign Application Priority Data
Mar. 18, 2024 (JP) 2024-042440

(51) Int. Cl. G01S 7/527; G01S 7/524; G01S 7/539; G01S 15/931

(52) U.S. Cl. CPC G01S 7/5273; G01S 7/524; G01S 7/539; G01S 15/931

(57) ABSTRACT

A sonar apparatus includes: a transmission circuit that transmits transmission signals of a plurality of frequencies; a reception circuit that receives reception signals corresponding to the transmission signals of the plurality of frequencies; and a detection circuit that detects an object based on the reception signals, in which the plurality of frequencies is determined such that a power of a composite signal of reception signals of at least one frequency of the plurality of frequencies is greater than a power of each reception signal making up the composite signal.

### TECHNICAL FIELD

The present disclosure relates to a sonar apparatus and an object detection method.

### BACKGROUND ART

In recent years, vehicles have been equipped with various types of sensors, including sonar apparatuses. Sonar apparatuses can detect the presence of objects by transmitting ultrasonic signals and receiving ultrasonic signals reflected by objects (also called targets), and can also measure the distance to objects from the time difference between the time of transmission and reception.

In the case of an object with a simple shape, such as a wall, the sonar apparatus receives one strong reception signal when the ultrasonic signal is reflected by the object.

On the other hand, in the case of an object with a complex shape, such as a human being, the ultrasonic signal is reflected at a plurality of points on the object, so the sonar apparatus receives the reception signal a plurality of times. In addition, when there is a plurality of objects, the sonar apparatus receives ultrasonic signals more than once.

When ultrasonic signals are received more than once, there is a possibility that the ultrasonic signals interfere with each other and the received power of the combined ultrasonic signal is reduced. For example, if an ultrasonic signal in a “sparse” state overlaps an ultrasonic signal in a “dense” state, the received wave power of the combined reception signal becomes weak, making it difficult to receive the ultrasonic signal well.

For example, if the difference (distance difference) between the first path length when the first reflected wave is received and the second path length when the second reflected wave is received is half a wavelength, it is difficult to receive the ultrasonic signal well because the “sparse” and “dense” ultrasonic signals are combined.

PTL 1 discloses a technique to reduce interference between ultrasonic signals by employing a chirp signal in the transmission signal. In addition, PTL 2 discloses a technique to reduce interference between ultrasonic signals by simultaneously transmitting ultrasonic signals of two different frequencies.

### Citation List

### Patent Literature

### PTL 1

WO2022/176442

### PTL 2

Japanese Patent Application Laid-Open No. 2019-035755

### PTL 3

WO2021/256414

### SUMMARY OF INVENTION

An object of the non-limitative embodiments of the present disclosure is to provide a sonar apparatus and an object detection method capable of reducing interference between ultrasonic signals.

A sonar apparatus according an aspect of the present disclosure includes: a transmission circuit that transmits transmission signals of a plurality of frequencies; a reception circuit that receives reception signals corresponding to the transmission signals of the plurality of frequencies; and a detection circuit that detects an object based on the reception signals, in which the plurality of frequencies is determined such that a power of a composite signal of reception signals of at least one frequency of the plurality of frequencies is greater than a power of each reception signal making up the composite signal.

A vehicle according an aspect of the present disclosure includes a sonar apparatus including: a transmission circuit that transmits transmission signals of a plurality of frequencies; a reception circuit that receives reception signals corresponding to the transmission signals of the plurality of frequencies; and a detection circuit that detects an object based on the reception signals, in which the plurality of frequencies is determined such that a power of a composite signal of reception signals of at least one frequency of the plurality of frequencies is greater than a power of each reception signal making up the composite signal.

An object detection method according an aspect of the present disclosure includes: transmitting transmission signals of a plurality of frequencies; receiving reception signals corresponding to the transmission signals of the plurality of frequencies; and detecting an object based on the reception signals, in which the plurality of frequencies is determined such that a power of a composite signal of reception signals of at least one frequency of the plurality of frequencies is greater than a power of each reception signal making up the composite signal.

According to an embodiment of the present disclosure, interference between ultrasonic signals can be reduced.

### BRIEF DESCRIPTION OF DRAWINGS

FIG. 1 is a top view of a vehicle;

FIG. 2 is a block diagram of a sonar apparatus;

FIG. 3 is a block diagram of a sonar apparatus including two transducers;

FIG. 4A is a diagram illustrating a received power for a path difference when ultrasonic waves of 31 kHz are transmitted;

FIG. 4B is a diagram illustrating a received power for a path difference when ultrasonic waves of 31 kHz are transmitted;

FIG. 5A is a diagram illustrating a received power for a path difference when ultrasonic waves of 62 kHz are transmitted;

FIG. 5B is a diagram illustrating a received power for a path difference when ultrasonic waves of 62 kHz are transmitted;

FIG. 6 is a diagram illustrating a state where two transducers located at adjacent locations respectively transmit and receive ultrasonic waves of frequency f1 and ultrasonic waves of frequency f2;

FIG. 7 is a diagram illustrating a state where two transducers located at the same location respectively transmit and receive the ultrasonic signal of frequency f1 and the ultrasonic signal of frequency f2;

FIG. 8A is a diagram illustrating a state where two transducers located at adjacent locations simultaneously transmit the ultrasonic signal of frequency f1 or the ultrasonic signal of frequency f2, and the both transducers receive the ultrasonic signal of frequency f1 and the ultrasonic signal of frequency f2;

FIG. 8B is a diagram illustrating a state where two transducers located at adjacent locations simultaneously transmit the ultrasonic signal of frequency f1 or the ultrasonic signal of frequency f2, and the both transducers receive the ultrasonic signal of frequency f1 and the ultrasonic signal of frequency f2;

FIG. 9A is a diagram illustrating a state where two transducers located at the same location simultaneously transmit the ultrasonic signal of frequency f1 or the ultrasonic signal of frequency f2, and the both transducers receive the ultrasonic signal of frequency f1 and the ultrasonic signal of frequency f2;

FIG. 9B is a diagram illustrating a state where two transducers located at the same location simultaneously transmit the ultrasonic signal of frequency f1 or the ultrasonic signal of frequency f2, and the both transducers receive the ultrasonic signal of frequency f1 and the ultrasonic signal of frequency f2;

FIG. 10A is a diagram illustrating a state where one transducer alternately transmits the ultrasonic signal of frequency f1 and the ultrasonic signal of frequency f2;

FIG. 10B is a diagram illustrating a state where one transducer alternately transmits the ultrasonic signal of frequency f1 and the ultrasonic signal of frequency f2;

FIG. 11 is a diagram illustrating an example of a reception intensity difference of successive frames of reception signals;

FIG. 12 is a diagram illustrating an example of a relationship between a threshold value and a reception intensity of successive frames of reception signals;

FIG. 13 is a diagram illustrating an example of a peak of a reception intensity of reception signals;

FIG. 14 is a diagram illustrating an example of a time when the reception intensity of reception signals is equal to or greater than a threshold value; and

FIG. 15 is an example of a flowchart of a process of transmitting transmission signals at a plurality of frequencies when it is determined that an object has a complex shape.

### DESCRIPTION OF EMBODIMENTS

An embodiment of the present disclosure is elaborated below with reference to the accompanying drawings. Note that embodiments described below are merely an example, and the present disclosure is not limited to the following embodiments.

However, more detailed explanations than necessary may be omitted. For example, detailed explanations of matters already well known or duplicate explanations of substantially identical configurations may be omitted. This is to avoid unnecessary redundancy in the following explanations and to facilitate the understanding of those skilled in the art.

The embodiments of the present disclosure are described below with reference to the drawings.

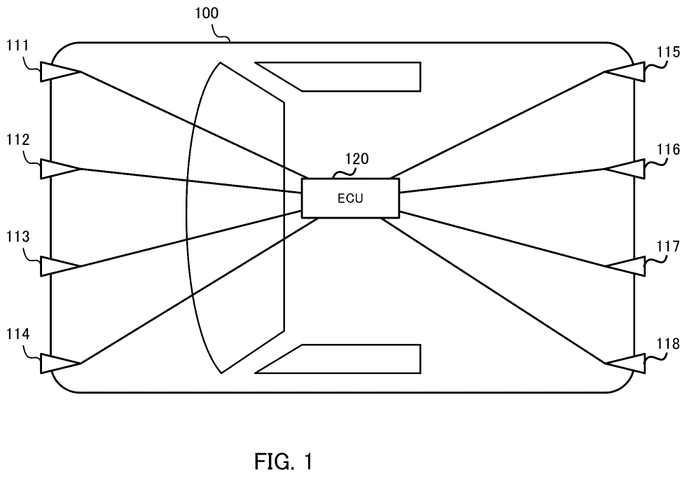

In FIG. 1, vehicle 100 includes sonar apparatuses 111 to 118, and electronic control unit (ECU) 120.

Sonar apparatus 111 is disposed on the right side of the front (Henceforth referred to as the front right: FR). Sonar apparatus 112 is disposed on the right side of the front center (Henceforth referred to as the front right center: FRC). Sonar apparatus 113 is disposed on the left side of the front center (Henceforth referred to as the front left center: FLC). Sonar apparatus 114 is disposed on the left side of the front (Henceforth referred to as the front left: FL).

In addition, sonar apparatus 115 is disposed on the right side of the rear (Henceforth referred to as the rear right (RR). Sonar apparatus 116 is disposed on the right side of the rear center (Henceforth referred to as the rear right center (RRC). Sonar apparatus 117 is disposed on the left side of the rear center (Henceforth referred to as the rear left center (RLC). Sonar apparatus 118 is disposed on the left side of the rear (Henceforth referred to as the rear left (RL). The number and arrangement of the sonar apparatus are not limited to FIG. 1.

ECU 120 is connected to sonar apparatuses 111 to 118. ECU 120 can perform vehicle control such as urgent brake operation and vehicle travel direction control on the basis of the detection result of sonar apparatuses 111 to 118.

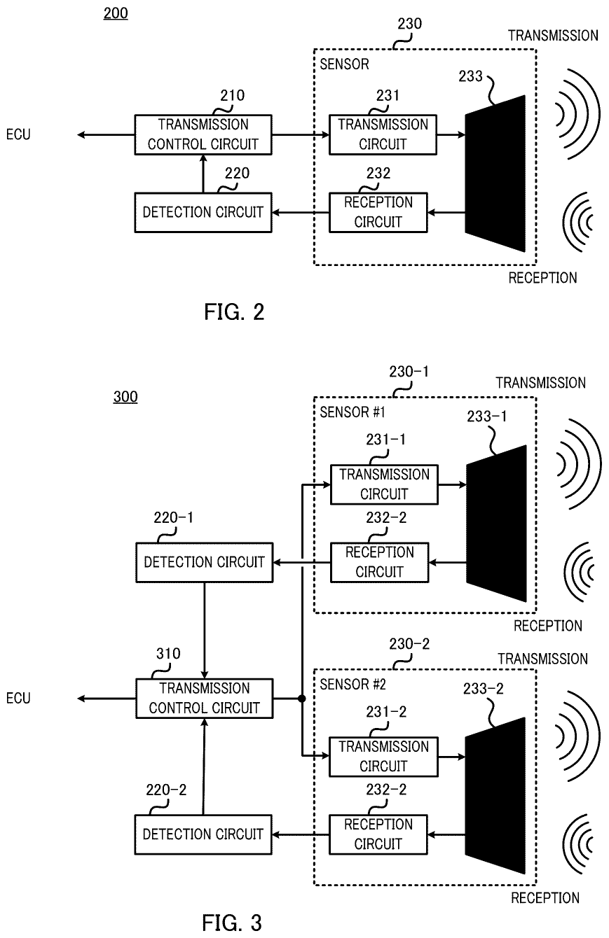

Details of the configurations of sonar apparatuses 111 to 118 mounted in vehicle 100 are described below. In FIG. 2, sonar apparatus 200 are used as sonar apparatuses 111 to 118.

Sonar apparatus 200 includes transmission control circuit 210, detection circuit 220, and sensor 230. Sensor 230 includes transmission circuit 231, reception circuit 232, and transducer 233. A plurality of sonar apparatuses or other sonar apparatuses may be mounted on the vehicle.

Transmission control circuit 210 outputs a detection result of an object to ECU 120. Transmission control circuit 210 controls transmission circuit 231. Transmission control circuit 210 controls the timing when transmission circuit 231 transmits ultrasonic waves, the frequency of the ultrasonic signal to be transmitted, and the transmission time of ultrasonic signals. The frequency of each ultrasonic signal to be transmitted is, for example, 62 kHz, 31 kHz and the like. Each ultrasonic signal may be a chirp signal. Transmission control circuit 210 sets the transmission time to, for example, 1 ms. When ultrasonic waves are transmitted in pulses, transmission control circuit 210 may set the number of pulses such as 64 pulses, and may set pulse width and pulse period.

Detection circuit 220 detects reception signals.

Under the control of transmission control circuit 210, transmission circuit 231 generates transmission signals, and transmits the generated transmission signal to transducer 233.

On the basis of the reception signals received by transducers 233, reception circuit 232 transmits reception signals to detection circuit 220. Reception circuit 232 may include a frequency filter, a Fourier transformer and the like.

Transducer 233 is an electroacoustic transducer that transmits ultrasonic signals on the basis of the transmission signal received from transmission circuit 231, and transmits the reception signal to reception circuit 232 on the basis of the received ultrasonic signal. It is difficult for transducer 233 to perform the reception while transmitting the ultrasonic signal, but transducer 233 may perform reception simultaneously with transmission.

In FIG. 3, sonar apparatus 300 is used as sonar apparatuses 111 to 118.

Sonar apparatus 300 includes transmission control circuit 310, detection circuits 220-1 and 220-2, and sensors 230-1 (sensor #1) and 230-2 (sensor #2). Detection circuit 220-1 and detection circuit 220-2 may have the same configuration as that of detection circuit 220 of FIG. 2, and sensor #1 and sensor #2 may have the same configuration as that of sensor 230 of FIG. 2. In addition, sensor #1 and sensor #2 may have different configurations.

Further, sensor #1 and sensor #2 may be disposed at the same location, such as on the right side of the front on the vehicle. Sensor #1 and sensor #2 may be disposed at adjacent locations such that sensor #1 is disposed on the right side of the front on the vehicle and sensor #2 is disposed at the right side of the front center on the vehicle, for example.

Other sonar apparatuses may be mounted in vehicle 100. In addition, both sonar apparatus 200 and sonar apparatus 300 may be mounted in vehicle 100.

The configuration is the same as configuration 1 except for transmission control circuit 310, and therefore the description thereof is omitted.

Transmission control circuit 310 outputs to ECU 120 the detection results of detection circuits 220-1 and 220-2. On the basis of the detection result of the object, ECU 120 can perform vehicle control such as urgent brake operation and vehicle travel direction control.

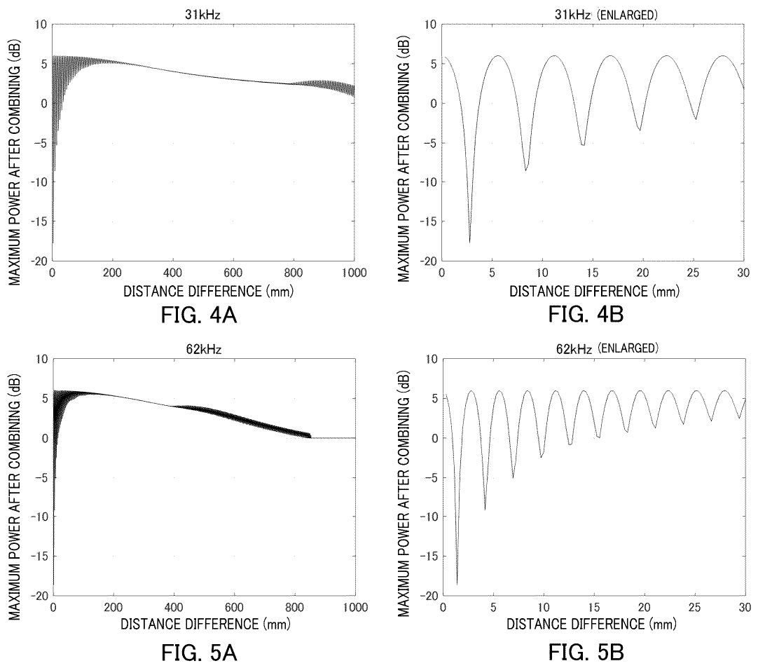

In FIGS. 4A, 4B, 5A and 5B, the abscissa indicates the path difference (distance difference) of two reflection waves, assuming that the received powers of the two reflections are equal to each other. FIGS. 4A and 5A illustrate the largest power after combining up the distance difference of 1000 mm.

In FIGS. 4A and 4B, the frequency is 31 kHz, and accordingly the wavelength of the ultrasonic signal is approximately 11 mm. When the distance difference of the two reflection points from the sonar apparatus is 2.75 mm, the round-trip path difference is 5.5 mm, thus resulting in a path difference corresponding to the half wavelength. Then, when ultrasonic signals with a half-wavelength phase shift are combined, the received power becomes weak. FIG. 4B shows that when a distance difference is 2.75 mm, the combined received power is about −18 dB.

In FIGS. 5A and 5B, the frequency is 62 kHz, and accordingly the wavelength of the ultrasonic signal is approximately 5.5 mm. When the distance difference of the two reflection points from the sonar apparatus is 2.75 mm, the round-trip path difference is 5.5 mm, thus resulting in a path difference of one wavelength. When ultrasonic signals with a phase difference of one wavelength are combined, the received power is strong. FIG. 5B shows that when a distance difference is 2.75 mm, the combined received power is about +6 dB.

Note that with reference to FIGS. 4A, 4B, 5A and 5B, when two ultrasonic signals that differ by 2.75 mm in distance difference from the sonar apparatus to two reflection points of the object are received, the combined received power is weak in the case of the ultrasonic signal of frequency 31 kHz as the combined received power is −18 dB, whereas the combined received power is strong in the case of the ultrasonic signal of frequency 62 kHz as the combined received power is +6 dB.

When the combined received power of the ultrasonic signals of frequency fis weak, the path length differences of ultrasonic signals is half a cycle. Even for the same path length difference, the path length difference is one cycle for the ultrasonic signal of frequency 2f with twice the frequency (wavelength half). Therefore, when the combined received power of the ultrasonic signals of frequency f is weak, the combined received power of ultrasonic signals of frequency 2f is strong.

Accordingly, by transmitting ultrasonic signals of frequency f and frequency 2f as the frequencies of two ultrasonic signals to be transmitted, a reception signal with the strong combined received power can be obtained for at least one of the two ultrasonic signals.

Note that while a case of transmitting ultrasonic signals of frequency f and frequency 2f is described above, it suffices that the combined ultrasonic signal of at least one frequency is strong. In addition, it suffices that a plurality of frequencies is determined such that the received power of the combined ultrasonic signal of at least one frequency of a plurality of frequencies is greater than the received power of each ultrasonic signal making up the combined reception signals.

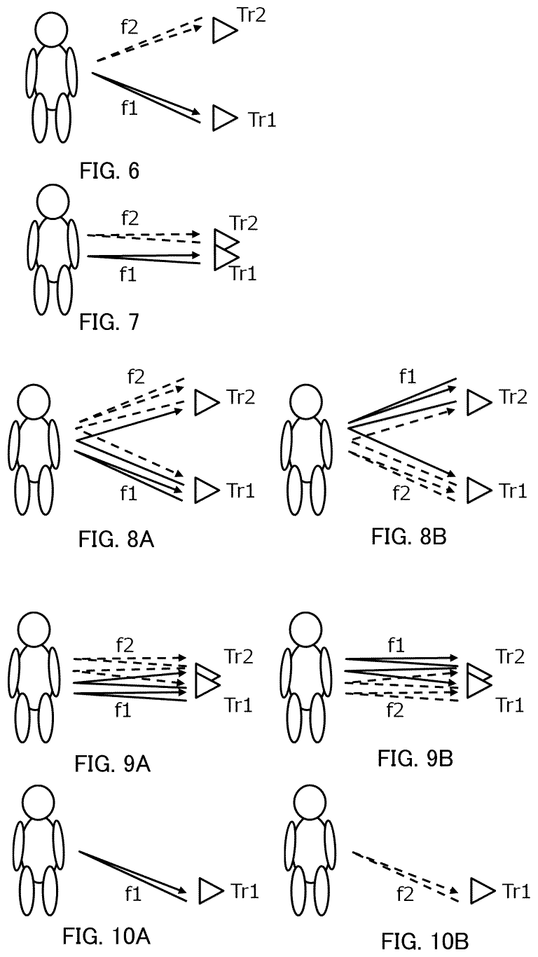

In FIG. 6, regarding two transducers located at adjacent locations, transducer Tr1 transmits and receives ultrasonic waves of frequency f1, and transducer Tr2 transmits and receives ultrasonic waves of frequency f2. In FIG. 6, transducer Tr1 is disposed on the right side of the front on the vehicle, and transducer Tr2 is disposed at the right side of the front center on the vehicle.

In FIG. 6, the ultrasonic signal of frequency f1 is indicated by solid line, and the ultrasonic signal of frequency f2 is indicated by dotted line (the same applies to FIGS. 7 to 10B described below). Frequency f2 is twice the frequency f1. Each frequency may be any frequency as long as the combined ultrasonic signal of at least one frequency is stronger.

For example, each of transducer Tr1 and transducer Tr2 may be transducer 233 with the configuration illustrated in FIG. 2, and may be provided in sonar apparatus 111 and sonar apparatus 112.

In this case, ECU 120 controls transmission control circuit 210 of sonar apparatus 111, and sonar apparatus 111 transmits and receives the ultrasonic signal of frequency f1. In addition, ECU 120 controls transmission control circuit 210 of sonar apparatus 112, and sonar apparatus 112 transmits and receives ultrasonic signal of frequency f2. The transmission of sonar apparatus 111 and the transmission of sonar apparatus 112 are simultaneous.

ECU 120 detects the object on the basis of the reception signal of frequency f1 received by sonar apparatus 111 and the reception signal of frequency f2 received by sonar apparatus 112. At least one of the sonar apparatuses can acquire a strong reception signal, and thus ECU 120 can detect the object on the basis of the strong reception signal.

In addition, transducer Tr1 and transducer Tr2 may be transducers 233-1 and 233-2, respectively with the configuration illustrated in FIG. 3, and may be provided on the right side of the front on the vehicle and at the right side of the front center on the vehicle.

Transmission control circuit 310 may cause sensor #1 including transducer Tr1 to transmit and receive the ultrasonic signal of frequency f1, and cause sensor #2 including transducer Tr2 to transmit and receive ultrasonic signal of frequency f2. The transmission of transducer Tr1 and the transmission of transducer Tr2 are simultaneous.

Transmission control circuit 310 detects the object on the basis of the reception signal of frequency f1 received by transducer Tr1 and the reception signal of frequency f2 received by transducer Tr2. At least one of the transducers can acquire a strong reception signal, and therefore transmission control circuit 310 can detect the object on the basis of the strong reception signal.

In FIG. 7, regarding two transducers located at the same location, transducer Tr1 transmits and receives the ultrasonic signal of frequency f1, and transducer Tr2 transmits and receives ultrasonic signal of frequency f2. For example, both transducer Tr1 and transducer Tr2 may be disposed on the right side of the front on the vehicle. The configuration is the same as that of FIG. 6 except that two transducers located at the same location. Note that the same location means a state where two transducers are disposed within a radius of 5 cm, for example.

In FIG. 8A, regarding two transducers located at adjacent locations, transducer Tr1 transmits the ultrasonic signal of frequency f1, transducer Tr2 transmits the ultrasonic signal of frequency f2 simultaneously with transducers Tr1, and transducers Tr1 and Tr2 receive the ultrasonic signal of frequency f1 and the ultrasonic signal of frequency f2.

In FIG. 8B, after the transmission and reception of FIG. 8A, transducer Tr1 transmits the ultrasonic signal of frequency f2, transducer Tr2 transmits the ultrasonic signal of frequency f1 simultaneously with transducer Tr1, and transducers Tr1 and Tr2 receive the ultrasonic signal of frequency f1 and the ultrasonic signal of frequency f2.

Transducer Tr1 may be disposed on the right side of the front on the vehicle, and transducer Tr2 may be disposed at the right of the front center on the vehicle. As a transducer that transmits and/or receives ultrasonic signals of a plurality of frequencies, a multiple resonance point transducers may be used (see, for example, PTL 3).

Note that the transmission illustrated in FIG. 8A and the transmission illustrated in FIG. 8B are alternately repeated.

For example, transducer Tr1 and transducer Tr2 may be transducer 233 with the configuration illustrated in FIG. 2, and may be provided in sonar apparatus 111 and sonar apparatus 112, respectively.

ECU 120 controls transmission control circuit 210 of sonar apparatus 111, and sonar apparatus 111 transmits the ultrasonic signal of frequency f1 and receives the ultrasonic signal of frequency f1 and the ultrasonic signal of frequency f2. In addition, ECU 120 controls transmission control circuit 210 of sonar apparatus 112, and sonar apparatus 112 transmits the ultrasonic signal of frequency f2 and receives the ultrasonic signal of frequency f1 and the ultrasonic signal of frequency f2. The transmission of sonar apparatus 111 and the transmission of sonar apparatus 112 are simultaneous.

ECU 120 detects the object on the basis of the reception signal of frequency f1 received by sonar apparatus 111, and the reception signal of frequency f2 received by sonar apparatus 112. Each sonar can receive the reception signal of at least one of the frequencies as a strong reception signal, and thus can detect the object on the basis of the strong reception signal.

In addition, transducer Tr1 and transducer Tr2 may be transducer 233-1 and transducer 233-2, respectively with the configuration illustrated in FIG. 3, transducer Tr1 may be disposed on the right side of the front on the vehicle, and, transducer Tr2 may be disposed at the right side of the front center on the vehicle.

Transmission control circuit 310 may cause sensor #1 including transducer Tr1 to transmit the ultrasonic signal of frequency f1, and cause sensor #2 including transducer Tr2 to transmit the ultrasonic signal of frequency f2. The transmission of transducer Tr1 and the transmission of transducer Tr2 are simultaneous.

Transmission control circuit 310 detects the object on the basis of the reception signal of frequency f1 and the reception signal of frequency f2 received by each sonar apparatus. Each transducer can receive the reception signal of at least one of the frequencies as a strong reception signal, and thus transmission control circuit 310 can detect the object on the basis of the strong reception signal.

In FIG. 9A, regarding two transducers located at the same location, transducer Tr1 and transducer Tr2 simultaneously transmit the ultrasonic signal of frequency f1 and the ultrasonic signal of frequency f2, respectively, and transducers Tr1 and Tr2 receive the ultrasonic signal of frequency f1 and the ultrasonic signal of frequency f2. In FIG. 9B, transducer Tr2 and transducer Tr1 simultaneously transmit the ultrasonic signal of frequency f1 and the ultrasonic signal of frequency f2, respectively, and transducers Tr1 and Tr2 receive the ultrasonic signal of frequency f1 and the ultrasonic signal of frequency f2. For example, both transducer Tr1 and transducer Tr2 may be disposed on the right side of the front on the vehicle. The configuration is the same as that of FIGS. 8A and 8B except that two transducers located at the same location.

In FIG. 10A, one transducer transmits the ultrasonic signal of frequency f1, and then transmits the ultrasonic signal of frequency f2 in FIG. 10B.

Even with one transducer, when the object is not moving, the reception signal of at least one of the frequencies can be acquired as a strong reception signal, and thus the object can be detected on the basis of the strong reception signal.

Note that the transmission in each embodiment may be implemented when it is determined that an object has a complex shape. In this case, detection circuit 220 determines whether the object has a complex shape on the basis of the reception signal. For example, the waveform of a reception signal reflected by an object with a simple shape, such as a wall and a poll, is substantially the same as that of the waveform of the transmission signal, while the waveform of a reception signal reflected by an object with a complex shape such as a human may have various waveforms.

When detection circuit 220 determines that the object has a complex shape, transmission control circuits 210 and 310 cause the transducer to transmit transmission signals at a plurality of frequencies. The method of determining whether the shape is a complex shape is described later.

In the processing of reception signals of a plurality of frequencies, the power consumption amount is larger than in the processing of reception signals of one frequency, but the power consumption amount can be reduced by transmitting transmission signals at a plurality of frequencies when it is determined that the object has a complex shape.

The following describes a method of determining whether the object has a complex shape. In the case where the object has a complex shape, the interference state of the reception signal significantly changes as the object and/or the vehicle moves, and thus the variation of the reception intensity of reception signals increases. Accordingly, whether the object has a complex shape can be determined by detecting the variation of the reception intensity of reception signals.

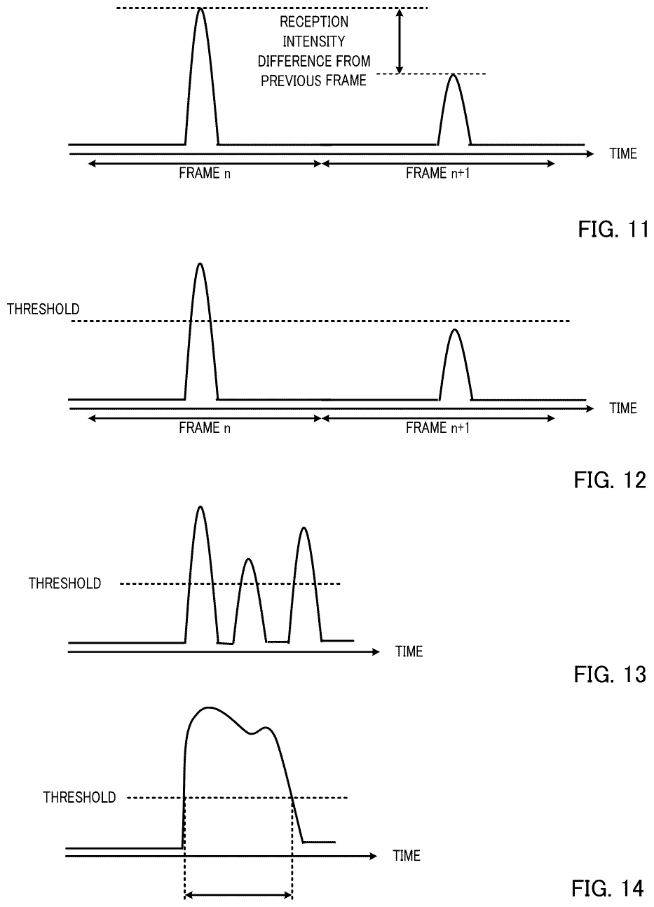

In FIG. 11, when the difference between the reception intensity of reception signals and the reception intensity of reception signals received previously (e.g., in a preceding frame) is equal to or greater than a threshold value, detection circuit 220 determines that the object has a complex shape. FIG. 11 illustrates an example in which the reception intensity of frame n+1 is smaller than that of frame n, but the reception intensity of frame n+1 may be larger than that of frame n.

In FIG. 12, when the reception intensity of reception signals is smaller than a threshold value, detection circuit 220 may determine that the object has a complex shape. When the variation of the reception intensity of reception signals is large, reception signals with a small reception intensity are also received. In addition, when the shape is complex, the reflection of the ultrasonic signal may possibly be complex and the reception intensity may possibly be weak. In view of this, whether the object has a complex shape can be determined by detecting the reception intensities. The threshold value may be a reception intensity in accordance with TOF (Time of Flight).

Note that the reception signal used for the determination is the signal received first, but it may be second or later reception signals. The reception signal used for the determination may be any signals as long as the signals can be determined to be reflected by the same object (such as reception signals whose difference in TOF is a predetermined value or smaller).

In the case where the object has a complex shape, and reflection signals reflected at various locations of the object (such as the body and the leg) are received, the number of the peaks of the reception intensity of reception signals (local maximum value) is large as illustrated in FIG. 13.

Therefore, detection circuit 220 may determine that the object has a complex shape when the number of the peaks of the reception intensity of reception signals is equal to or greater than the threshold value.

In addition, detection circuit 220 may determine that the object has a complex shape when the number of portions where the reception signal exceeds the threshold value is equal to or greater than the threshold value. By using the portion where the threshold value is exceeded instead of the peak, the number of peaks can be approximated by the number of the portions where the threshold value is exceeded.

In this case, the determination whether the object has a complex shape is performed on the basis of the peak of the signal received first or the number of the portions where the threshold value is exceeded, but it may be performed on the basis of the peak of the reception signals received second or later or the number of the portions where the threshold value is exceeded.

In addition, the determination whether the object has a complex shape may be performed by the following method.

In the case where the object has a complex shape, and reflection signals reflected at various locations of the object (such as the body and the leg) are receive in an overlapped manner, the width of the reception signal is wide as illustrated in FIG. 14.

Therefore, when the time for which the reception intensity of reception signals is equal to or greater than a first threshold value is equal to or greater than a second threshold value, detection circuit 220 may determine that the object has a complex shape.

In this case, the determination whether the object has a complex shape is performed on the basis of the reception signal received first, but it may be performed on the basis of the reception signal received second or later.

In addition, the threshold value in each method described above may be set in a fixed manner, or in a changeable manner in accordance with historical reception status.

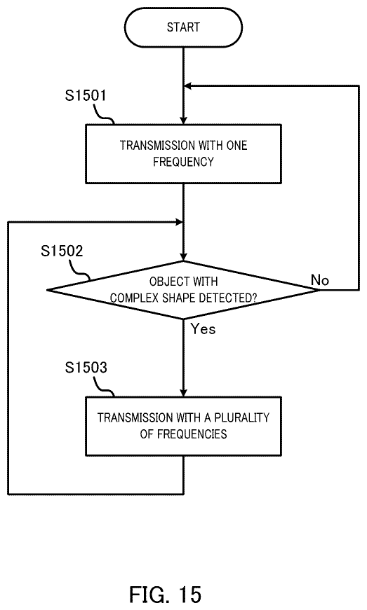

Next, a procedure executed by transmission control circuit 310 is described below with reference to FIG. 15. The process illustrated in FIG. 15 is executed by transmission control circuit 310, but it may be executed by ECU 120.

First, transmission control circuit 310 transmits a transmission signal in one frequency to the transducer (step S1501).

Then, transmission control circuit 310 determines whether an object with a complex shape has been detected (step S1502).

When it is determined that an object with a complex shape has been detected (step S1502, Yes), transmission control circuit 310 transmits ultrasonic signals of a plurality of frequencies to the transducer (step S1503).

The method of transmitting a plurality of frequencies may be any of the transmission methods described with reference to FIG. 6 to FIG. 10B. When ultrasonic signals of a plurality of frequencies are transmitted, the process is returned to step S1502 to determine whether an object with a complex shape has been detected.

When it is not determined that an object with a complex shape has been detected by detection circuit 220 (step S1502, No), transmission control circuit 310 returns to step S1501, and transmits a transmission signal in one frequency to the transducer.

In this manner, when it is determined that the object has a complex shape such as a human, the power consumption amount can be reduced by transmitting transmission signals at a plurality of frequencies.

The above description of the embodiments has been given with reference to the drawings, but the present disclosure is not limited to such examples. It is clear that those skilled in the art can conceive of various examples of changes or modifications within the scope of the claims. It is understood that such changes or modifications also fall within the technical scope of the present disclosure. In addition, each component of the embodiment may be arbitrarily combined to the extent that the intent of the present disclosure is not departed from.

In the above description, the notation “ . . . part” used for each component may be replaced by other notations such as “ . . . assembly,” “ . . . circuitry,” “ . . . device,” “ . . . unit,” or “ . . . module. The sonar apparatus may also be configured to be executed by a processor using a program stored in a memory in the ECU.
(1) A sonar apparatus according an aspect of the present disclosure includes: a transmission circuit that transmits transmission signals of a plurality of frequencies; a reception circuit that receives reception signals corresponding to the transmission signals of the plurality of frequencies; and a detection circuit that detects an object based on the reception signals, in which the plurality of frequencies is determined such that a power of a composite signal of reception signals of at least one frequency of the plurality of frequencies is greater than a power of each reception signal making up the composite signal.
(2) In the sonar apparatus of (1), in a sonar apparatus according an aspect of the present disclosure, the transmission signal is a chirp signal.
(3) In the sonar apparatus of (1), in a sonar apparatus according an aspect of the present disclosure, the plurality of frequencies includes a first frequency and a second frequency that is twice the first frequency.
(4) In the sonar apparatus of (1), in a sonar apparatus according an aspect of the present disclosure, through a transducer including a plurality of resonance points, the transmission circuit transmits the transmission signal at the plurality of frequencies corresponding to the plurality of resonance points.
(5) In the sonar apparatus of (1), the sonar apparatus according an aspect of the present disclosure further includes: a transmission control circuit that controls a method of transmitting the transmission signals of the plurality of frequencies based on the reception signal.
(6) In the sonar apparatus of (5), in a sonar apparatus according an aspect of the present disclosure, the transmission control circuit controls a plurality of transducers to simultaneously transmit each transmission signal making up the transmission signals of the plurality of frequencies.
(7) In the sonar apparatus of (5), in a sonar apparatus according an aspect of the present disclosure, the transmission control circuit controls one transducer to transmit each transmission signal making up the transmission signals of the plurality of frequencies at different timings.
(8) In the sonar apparatus of (5), a sonar apparatus according an aspect of the present disclosure further includes a detection circuit that determines whether the object has a complex shape based on the reception signal, in which when it is determined that the object has a complex shape, the transmission control circuit transmits the transmission signals of the plurality of frequencies, and when it is not determined that the object has a complex shape, the transmission control circuit transmits a transmission signal of a single frequency.
(9) In the sonar apparatus of (8), in a sonar apparatus according an aspect of the present disclosure, the detection circuit determines whether the object has a complex shape based on a reception intensity of a reception signal.
(10) In the sonar apparatus of (8), in a sonar apparatus according an aspect of the present disclosure, the detection circuit determines whether the object has a complex shape based on a number of peaks of the reception signals, or a number of portions where the reception signals exceed a threshold value.
(11) In the sonar apparatus of (8), in a sonar apparatus according an aspect of the present disclosure, the detection circuit determines whether the object has a complex shape based on a reception time of the reception signal.
(12) A vehicle according an aspect of the present disclosure in which the sonar apparatus (1) is mounted.
(13) An object detection method according an aspect of the present disclosure includes: transmitting transmission signals of a plurality of frequencies; receiving reception signals corresponding to the transmission signals of the plurality of frequencies; and detecting an object based on the reception signals, in which the plurality of frequencies is determined such that a power of a composite signal of reception signals of at least one frequency of the plurality of frequencies is greater than a power of each reception signal making up the composite signal.
(14) In the object detection method of (13), in an object detection method according an aspect of the present disclosure, the transmission signal is a chirp signal.
(15) In the object detection method of (13), in an object detection method according an aspect of the present disclosure, the plurality of frequencies includes a first frequency and a second frequency that is twice the first frequency.
(16) In the object detection method of (13), in an object detection method according an aspect of the present disclosure, through a transducer including a plurality of resonance points, the transmission signal is transmitted at the plurality of frequencies corresponding to the plurality of resonance points.
(17) In the object detection method of (13), in an object detection method according an aspect of the present disclosure, a method of transmitting the transmission signals of the plurality of frequencies is controlled based on the reception signal.
(18) In the object detection method of (17), in an object detection method according an aspect of the present disclosure, the transmission signal is transmitted by a plurality of transducers, and the plurality of transducers is controlled to simultaneously transmit each transmission signal making up the transmission signals of the plurality of frequencies.
(19) In the object detection method of (17), in an object detection method according an aspect of the present disclosure, the transmission signal is transmitted by one transducer, and the one transducer is controlled to transmit each transmission signal making up the transmission signals of the plurality of frequencies at different timings.
(20) In the object detection method of (17), an object detection method according an aspect of the present disclosure further includes: determining whether the object has a complex shape based on the reception signal; and performing a control such that the transmission signals of the plurality of frequencies is transmitted when it is determined that the object has a complex shape, whereas a transmission signal of a single frequency is transmitted when it is not determined that the object has a complex shape.

While various embodiments have been described herein above, it is to be appreciated that various changes in form and detail may be made without departing from the spirit and scope of the invention(s) presently or hereafter claimed.

This application is entitled to and claims the benefit of Japanese Patent Application No. 2024-042440 filed on Mar. 18, 2024, the disclosure each of which including the specification, drawings and abstract is incorporated herein by reference in its entirety.

### REFERENCE SIGNS LIST

100: Vehicle
111 to 118, 200, 300: Sonar apparatus
120: ECU
210, 310: Transmission control circuit
220: Detection circuit
230: Sensor
231: Transmission circuit
232: Reception circuit
233: Transducer

1. A sonar apparatus comprising:
a transmission circuit which, in operation, transmits transmission signals corresponding to a plurality of frequencies;
a reception circuit which, in operation, receives reception signals that the transmission signals is reflected at a plurality of reflection points of an object; and
a detection circuit which, in operation, detects the object based on a composited signal obtained by combining the reception signals,
wherein a power of the composited signal is greater than a power of each of the reception signals.

2. The sonar apparatus according to claim 1, wherein the transmission signal is a chirp signal.

3. The sonar apparatus according to claim 1, wherein the plurality of frequencies includes a first frequency and a second frequency that is twice the first frequency.

4. The sonar apparatus according to claim 1, wherein through one or more transducers including a plurality of resonance points, the transmission circuit which, in operation, transmits the transmission signals at the plurality of frequencies corresponding to the plurality of resonance points.

5. The sonar apparatus according to claim 1, further comprising: a transmission control circuit that controls a method of transmitting the transmission signals of the plurality of frequencies based on the reception signal.

6. The sonar apparatus according to claim 4, wherein the one or more transducers are a plurality of transducers, and
the plurality of transducers which, in operation, simultaneously transmit each of the transmission signals.

7. The sonar apparatus according to claim 5, wherein one of the one or more transducers which, in operation, transmit one of the transmission signals at timings different from rest of the one or more transducers.

8. The sonar apparatus according to claim 5, further comprising a detection circuit which, in operation, determines whether the object has a complex shape based on the reception signal,
wherein when it is determined that the object has a complex shape, the transmission control circuit transmits the transmission signals of the plurality of frequencies, and wherein when it is not determined that the object has a complex shape, the transmission control circuit transmits a transmission signal of a single frequency.

9. The sonar apparatus according to claim 8, wherein the detection circuit which, in operation, determines whether the object has a complex shape based on a reception intensity of a reception signal.

10. The sonar apparatus according to claim 8, wherein the detection circuit which, in operation, determines whether the object has a complex shape based on a number of peaks of the reception signals, or a number of portions where the reception signals exceed a threshold value.

11. The sonar apparatus according to claim 8, wherein the detection circuit which, in operation, determines whether the object has a complex shape based on a reception time of the reception signal.

12. A vehicle in which the sonar apparatus according to claim 1 is mounted.

13. An object detection method comprising:
transmitting transmission signals corresponding to a plurality of frequencies;
receiving reception signals that the transmission signals is reflected at a plurality of reflection points of an object; and
detecting the object based on a composited signal obtained by combining the reception signals,
wherein a power of the composited signal is greater than a power of each of the reception signals.

14. The object detection method according to claim 13, wherein the transmission signal is a chirp signal.

15. The object detection method according to claim 13, wherein the plurality of frequencies includes a first frequency and a second frequency that is twice the first frequency.

16. The object detection method according to claim 13, wherein through one or more transducers including a plurality of resonance points, the transmission signals are transmitted at the plurality of frequencies corresponding to the plurality of resonance points.

17. The object detection method according to claim 13, wherein a method of transmitting the transmission signals of the plurality of frequencies is controlled based on the reception signal.

18. The object detection method according to claim 16,
wherein the one or more transducers are a plurality of transducers, and the transmission signals are transmitted by the plurality of transducers, and
wherein further comprising:
simultaneously transmitting, by the plurality of transducers, each of the transmission signals making up the transmission signals of the plurality of frequencies.

19. The object detection method according to claim 17, further comprising:
transmitting, by one of the one or more transducers, one of the transmission signals at timings different from rest of the one or more transducers.

20. The object detection method according to claim 17, further comprising:
determining whether the object has a complex shape based on the reception signal; and
performing a control such that the transmission signals of the plurality of frequencies is transmitted when it is determined that the object has a complex shape, whereas a transmission signal of a single frequency is transmitted when it is not determined that the object has a complex shape.
